(19) United States
(12) Patent Application Publication
(10) Pub. No.: US 2013/0294975 A1
(43) Pub. Date: Nov. 7, 2013

(54) FIBER OPTIC APPARATUS FOR OXYGEN SENSING

(71) Applicants: Yong Won Song, Daejeon (KR); Jung Ah Lim, Boryeong (KR); Jae Min Hong, Seoul (KR); Nam Su Kang, Seoul (KR); Hee Dok Choi, Incheon (KR)

(72) Inventors: Yong Won Song, Daejeon (KR); Jung Ah Lim, Boryeong (KR); Jae Min Hong, Seoul (KR); Nam Su Kang, Seoul (KR); Hee Dok Choi, Incheon (KR)

(73) Assignee: KOREA INSTITUTE OF SCIENCE AND TECHNOLOGY, Seoul (KR)

(21) Appl. No.: 13/869,394

(22) Filed: Apr. 24, 2013

(30) Foreign Application Priority Data
Apr. 24, 2012 (KR) 10-2012-0042821

(51) Int. Cl. G01N 21/41

(52) U.S. Cl. CPC G01N 21/412
USPC 422/83

(57) ABSTRACT

An apparatus for oxygen sensing is provided. The apparatus for oxygen sensing includes: a header part to generate interference wave to light generated in a light source by the principle of fiber Fabry-Perot interferometer; and an optical spectrum analyzer to decide existence of oxygen based on change of spectrum periodicity of the above interference wave, in which the header part includes a sensing material of which effective refractive index changes by combination with the oxygen and the above interference wave changes its spectrum periodicity depending on change of effective refractive index of the above sensing material.

### CROSS-REFERENCE TO RELATED APPLICATION

Pursuant to 35 U.S.C. §119(a), this application claims the benefit of earlier filing date and right of priority to Korean Application No. 10-2012-0042821, filed on Apr. 24, 2012, the contents of which is incorporated by reference herein in its entirety.

### BACKGROUND OF THE INVENTION

1. Field of the Invention

The present invention relates to a fiber optic apparatus for oxygen sensing by using fiber Fabry-Perot interferometer.

2. Background of the Invention

With continuous rise of interest on environment, development of a sensor to sense oxygen concentration contained in exhaust gas has been considered important recently.

Conventional oxygen sensors use electrochemical methods such as Galvanic and Clark type method and resistance measurement methods to measure change of resistance against oxides such as ZrO₂, TiO₂, and SnO₂, representatively.

The electrochemical method is a method to measure current according to electrochemical reaction in inner electrolytes, by making only oxygen molecules transmitted into the sensor through the transmission membrane made of polymer. In this method, a certain pressure difference is required for target gas or liquid to pass through the transmission membrane and usually the measurement takes long time because of slow reaction time. Moreover, there is a problem also that oxygen concentration may fluctuate during measurement by having a mechanism that oxygen molecules are consumed in generating current.

On the other hand, the resistance measuring methods generally use oxides, so it has high operating temperature over 150° C. From this, it requires local provision of power necessary for each sensor element. In addition, commercialized oxygen sensors have slow reaction time from several to several tens of minutes to low concentration oxygen.

### SUMMARY OF THE INVENTION

The present invention provides an apparatus for oxygen sensing that is operated at room temperature with fast reaction velocity, absorbs no oxygen to be sensed, and needs no separate power supply.

In addition, the present invention provides an apparatus for oxygen sensing that uses globins forming reversible coordinate bond with oxygen as a sensing material and measures wavelength change of light caused by absorption and desorption between oxygen and the sensing material using fiber Fabry-Perot interferometer.

The apparatus for oxygen sensing described in the present invention includes a header part to generate interference wave to light generated in a light source by the principle of fiber Fabry-Perot interferometer (FFPI), and an optical spectrum analyzer (OSA) to decide existence of oxygen based on change of spectrum periodicity of the above interference wave, wherein the header part includes a sensing material of which effective refractive index changes by combination with the oxygen and the spectrum periodicity of the above interference wave changes depending on change of effective refractive index of the above sensing material.

In addition, the above sensing material is one of globins including hemoglobin, myoglobin, and metal prophyrin.

In addition, the apparatus includes also a circulator that guides the light generated in the light source and entering into the first port to the head part linked to the second port, and guides the interference wave generated in the header part to the OSA linked to the third port.

In addition, the header part includes also a polymer that provides transfer route of the light generated in the light source, is coated at the end of the optical fiber supported by ferrule, and acts as 2 mirrors of the FFPI and the sensing material is coated on the surface of the above polymer.

In addition, the above polymer is a polymer including poly-dimethylsiloxane (PDMS) that is in solid state at room temperature or its operation temperature.

In addition, the above polymer is coated in a shape of curved surface including a plane or a hemisphere.

In addition, the header part of the apparatus for oxygen sensing according to the present invention includes an optical fiber providing a transfer route of the light generated in the light source using total reflection and supported by the ferrule, a polymer coated at the end of the optical fiber and acting as 2 mirrors of the FFPI, and a sensing material coated at the end of the above optical fiber and generating an interference wave by the principle of FFPI to the light generated in the light source and entering through the optical fiber, wherein the above sensing material changes its effective refractive index, and the above interference wave changes its wave length depending on the effective refractive index change of the above sensing material.

In addition, the above sensing material is one of globins including hemoglobin, myoglobin, and metal prophyrin.

In addition, the above polymer is one of polymers including poly-dimethylsiloxane (PDMS) that is in solid state at room temperature or its operation to temperature.

In addition, the above polymer is coated in a shape of curved surface including a plane or a hemisphere.

### Effects of Invention

It is possible to be operated with fast sensing time in sensing low concentrate of oxygen due to rapid reaction time and sense the oxygen accurately without absorption of oxygen and separate power supply.

According to the apparatus for oxygen sensing described in the present invention, because it does not require measurement of current change by using FFPI, it is capable of remote control of the sensor and reacting sensitively to the low concentration oxygen to sense the oxygen.

In addition, according to the apparatus for oxygen sensing described in the present invention, it has a merit that because it uses both ends of the optical fiber, it is easy to apply it to a space or a system to be measured.

In addition, according to the apparatus for oxygen sensing described in the present invention, it is possible to control multiple sensor header parts simultaneously due to good expandability of the sensor using an optical fiber coupler or a multiplexer.

### BRIEF DESCRIPTION OF THE DRAWINGS

FIG. 1 is a diagram to explain the principle of FFPI.

FIG. 2 is a block diagram illustrating the apparatus for oxygen sensing by using FFPI described in the present invention.

FIG. 3 is a diagram showing detailed structure of the header part in the apparatus for oxygen sensing according to an example of the present invention.

FIG. 4. Is a flowchart illustrating a method for oxygen sensing according to an example of the present invention.

FIG. 5 is a microscopic image of the header part in the apparatus for oxygen sensing according to an example of the present invention.

FIG. 6 is a diagram showing results of wavelength change of the reflected interference wave in the apparatus for oxygen sensing according to an example of the present invention.

FIG. 7 is a diagram showing results of spectral shift of the interference patterns with respect to the oxygen concentration change in the apparatus for oxygen sensing according to an example of the present invention.

FIG. 8 is a diagram showing results of wavelength change of the interference wave depending on oxygen concentration change in the apparatus for oxygen sensing according to an example of the present invention.

### DETAILED DESCRIPTION OF THE INVENTION

Unless differently defined, all the terms used herein with including technical or scientific terms have the same meaning as terms generally understood by those skilled in the art relating to the field of the present invention. Terms defined in a general dictionary should be understood so as to have the same meanings as contextual meanings of the related art. Unless definitely defined in the present invention, the terms are not interpreted as ideal or excessively formal meanings. Furthermore, when the technical terms used in the present invention are unsuitable technical terms that do not precisely express the techniques of the present invention, the unsuitable technical terms should be replaced by suitable technical terms that can be understood by those skilled in the art. The general terms used in the present invention should be interpreted based on the previous or next contexts, but should not be interpreted as an excessively narrowed meaning.

A singular expression includes a plural concept unless there is a contextually distinctive difference therebetween. In the present invention, a term of “include” or “have” should not be interpreted as if it absolutely includes a plurality of components or steps of the specification. Rather, the term of “include” or “have” may not include some components or some steps, or may further include additional components.

The suffixes attached to components of the portable terminal, such as ‘portion’ were used for facilitation of the detailed description of the present invention. Therefore, the suffixes do not have different meanings from each other.

If it is regarded that detailed descriptions of the related art are not within the range of the present invention, the detailed descriptions will be omitted. Furthermore, it should also be understood that embodiments are not limited by any of the details of the foregoing description, but rather should be construed broadly within its spirit and scope and it is intended that the present invention cover modifications and variations of this invention provided they come within the scope of the appended claims and their equivalents.

Further scope of applicability of the present application will become more apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from the detailed description.

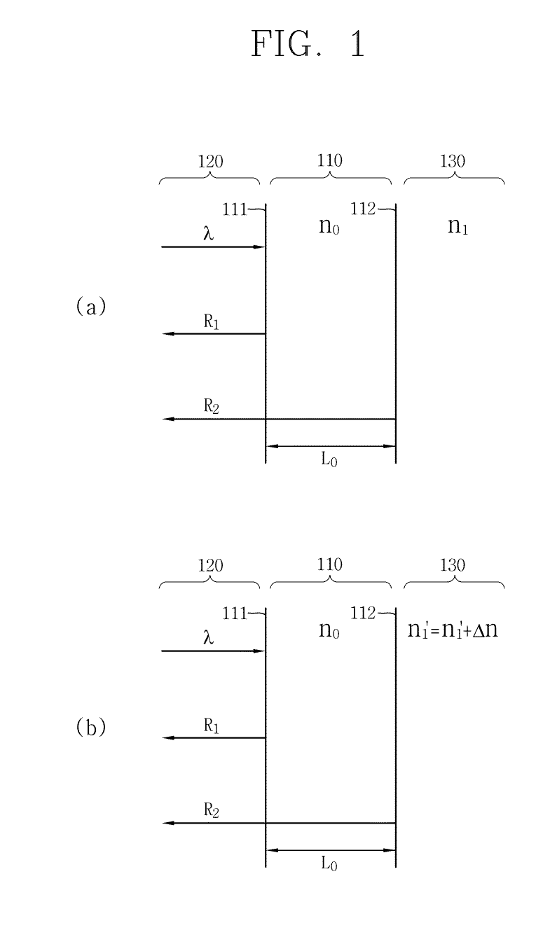

FIG. 1 is a diagram to explain the principle of FFPI

The FFPI uses the principle to analyze spectrum using wavelength change of interference wave reflected from one or two mirror. This is explained concretely below.

FIG. 1 (a) illustrates a case that 2 reflectable mirrors of the FFPI (111, 112) comprises a distance, L₀, the first material (110) filling the space between the above mirrors and having a refractive index, n₀, and the second material (130) filling the outside of the above mirrors and having a refractive index, n₁.

The above 2 mirrors (111, 112) comprises the first mirror (111), an interface to the first material (110) between optical fiber (120) and the first and the second mirror (112), an interface between the above first material (110) and the second material.

An optic fiber (120) linked to a side of the above first mirror (111) irradiates a light with a wavelength (λ) to the first mirror (111). The light passing through the above first mirror (111) enters to the above material (110) in contact and connected with the above optic fiber (120). Wherein, when the above optic fiber (120) and the above material (1) are parallel and connected each other, the above light may enter vertically.

The light entering into the above first material (110) is irradiated to the second mirror (112) and then irradiated to the second material (130).

For the above light moving along the above route, a part is reflected and the other part is transmitted on the first mirror (111) and the above second mirror (112), because of refractive index difference to the above optical fiber (120), the above first material (110) and the second material (130).

Accordingly, the light which is reflected and transmitted between the above 2 mirrors (111, 112) repeatedly, generates multiple reflected waves returning to the above optical fiber (120). Namely, the above light can generate the first reflection wave (R1) reflected from the first mirror (111) and returning to the optical fiber (120) and the second reflection wave (R2) reflected from the second mirror (112) and returning to the optical fiber (120).

Here, wavelengths of the above first reflection wave (R1) and the above second reflection (R2) are calculated by below Mathematical Equation 1 and Mathematical Equation 2.

$${r}_{1}^{2} = {( \frac{n - {n}_{0}}{n + {n}_{0}} )}^{2} \qquad [ Mathematical Equation 1 ]$$

Wherein, r₁ is wavelength of the first reflection wave, n is refractive index of optical fiber, and n₀ is refractive index of the first material.

$${r}_{2}^{2} = {( \frac{{n}_{0} - {n}_{1}}{{n}_{0} + {n}_{1}} )}^{2} \qquad [ Mathematical Equation 2 ]$$

Wherein, r₂ is wavelength of the second reflection wave, n₀ is refractive index of the first material, and n₁ is refractive index of the first material.

The above multiple reflection waves (R1, R2) induce interference each other in the above optical fiber (120) and generate a final interference wave with finally decided wavelength from the interference.

Here, the wavelength of final interference wave may be calculated by below Mathematical Equation 3.

$$R ( λ ) = \frac{{R}_{1} + {R}_{2} + 2 \sqrt{{R}_{1} {R}_{2}} cos φ}{1 + {R}_{1} {R}_{2} + 2 \sqrt{{R}_{1} {R}_{2}} cos φ} \qquad [ Mathematical Equation 3 ]$$

Wherein, the above R₁, R₂, and φ are below Mathematical Equation 4, 5. and 5.

$$\begin{matrix}{R}_{1} = {r}_{1}^{2} & [ Mathematical Equation 4 ] \\ {R}_{2} = {r}_{2}^{2} & [ Mathematical Equation 5 ] \\ φ = \frac{4 π {n}_{0} {L}_{0}}{λ} & [ Mathematical Equation 6 ]\end{matrix}$$

Wherein, R(λ) is wavelength of the final interference wave by wavelength of incident wave, r₁ is wavelength of the first reflection wave, r₂ is wavelength of the second reflection wave, n₀ is refractive index of the first material, L₀ is distance between the 2 mirrors, and λ is wavelength of the incident wave.

It is referred as FFPI to use this periodicity change by wavelength change of the final interference wave spectrum for the purpose of sensing a material.

In this FFPI, when the refractive index (or effective refractive index) of the above first or second material (110, 130) composing the interferometer, wavelength of the first or the second reflection wave formed on the above 2 mirrors changes and wavelength of the above interference wave generated by their interference changes also, so spectrum periodicity of the interference wave is changes.

The FFPI can sense external effects to make changes in refractive index of the first or the second material of the FFPI that can be detected by the spectrum periodicity of the interference wave.

FIG. 1 (b) illustrates a case that refractive index of a material composing interferometer changes in the FFPI. In other words. FIG. 1. (b) shows a case that refractive index (n₁) of the above second material (130) increases by Δn and becomes n₁′.

When the refractive index of the above second material (130) changes by an external effect, the wavelength of the second reflection wave (R2) generated by the second mirror (112), so the spectrum periodicity of the above interference wave changes also.

The FFPI can sense external effects to make changes in the refractive index of the first or the second material of the FFPI that can be detected by the spectrum periodicity change of the interference wave.

Next, an apparatus for oxygen sensing by using the principle of FFPI is described.

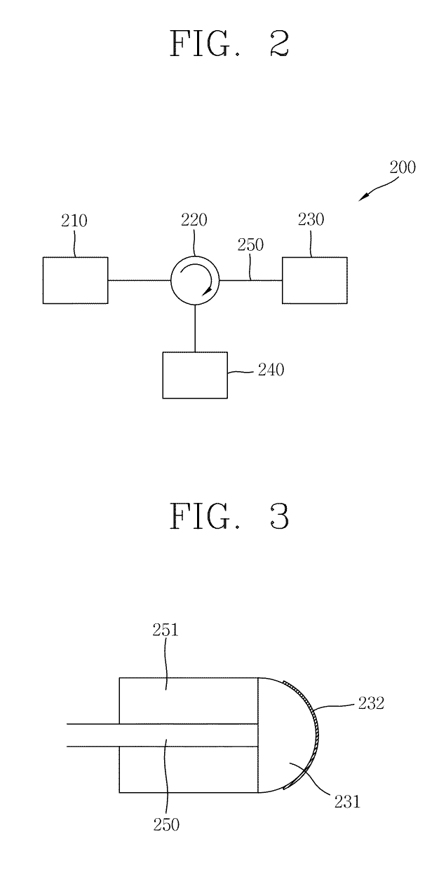

FIG. 2 is a block diagram illustrating the apparatus for oxygen sensing by using the FFPI described in the present invention.

As shown in the FIG. 2, the above apparatus for oxygen sensing (200) may include a light source (210), a circulator (220), a header part (230), an OSA (240), and optical fibers (250) also.

The above light source (210) can produce white or broadband light. The light produced in the above light source (210) may be irradiated into an input port of the circulator (220). In addition, the above light may be guided into the header part (230) through the circulator (220).

The above light source (210) may be a laser diode or a broadband light source. Or, the above light source (210) may be an Er-doped fiber amplifier (EDFA).

The above circulator (220) may have the first˜the third port. The above circulator (220) may be configured to guide the light entering into the first port to the second port and guide the light entering into the second port to the third port.

According to another example of the present invention, the above circulator (220) can guide the light generated in the light source (210) and entering into the first port to the header part (230) connected to the second port and the interference wave generated in the header part (230) and entering to the second port to the OSA (240) connected to the third port.

Namely, the above circulator (220) is located among the light source (210), the header part (230), and the OSA (240) and can convert the route of light generated in the light source (210). Wherein, the above first port of the circulator may be connected to the light source (210), the above second port may be connected to the header part (230), and the third port may be connected to the OSA (240).

The above circulator (220) may include a mirror or a polarized light control element to reflect light to control the light path.

The above header part (230) produces an interference wave by the principle of FFPI. The above header part (230) can generate the interference wave to the light irradiated by the light source (210) by the principle of FFPI.

According to another example of the present invention, the above header part (230) may include a sensing material to sense oxygen and generate the interference wave. The above sensing material may change its effective refractive index by combination with oxygen. In addition, the above interference wave may change its spectrum periodicity by effective refractive index change of the sensing material.

According to another example of the present invention, the above sensing material may be at least one of globins including hemoglobin, myoglobin, and metal-porphyrin.

According to another example of the present invention, the above header part (230) may include a polymer that acts as the 2 mirrors to generate the above interference wave. The above sensing material may make the light irradiated by the light source (210) generate the interference wave having a certain spectrum periodicity by repeated reflect and transmission using the both ends of the above polymer as 2 mirrors.

More concrete structure of the above header part (230) will be described in below FIG. 3 as an example in detail.

The OSA (240) decides existence of oxygen, based on the wavelength change of interference wave, namely change of spectrum periodicity. In other words, the OSA (240) may decide existence of oxygen, based on change of the spectrum periodicity by wavelength change of interference wave generated in the header part (230).

For this, the above OSA (240) can measure spectrum of the above interference wave. The above OSA (240) can receive the interference wave entering to the OSA (240) with a receiver (for example, photo diode etc.) and convert it to current to display its spectrum. On the spectrum of the light by the above OSA (240), periodicity of the interference wave, wavelength at specific position, and change ratio of the wavelength may be included.

Each component composing above apparatus for oxygen sensing (200) may be connected by the above optical fibers (250). Or the above component may be connected through planar optical waveguide instead of the above optical fiber (250).

The above optical fiber (250) may provide a transfer route to the light generated in the above light source (210) using reflection of the light. The above optical fiber may connect each component composing the above apparatus for oxygen sensing (200) and provide a transfer route to the light generated in the light source (210) to move among the components.

Concretely, the above optical fiber (250) may make the light generated in the light source (210) irradiated to the header part (230) through the circulator (220) and make the interference wave generated in the header part irradiated to the OSA (240) through the circulator (220).

The above optical fiber (250) may consist of core and cladding inducing total reflection of light to make the light move without loss of energy.

The above optical fiber (250) may be supported by ferrule. The above optical fiber (250) may be inserted to the above ferrule to compose an assembly. The above ferrule may surround lateral side of the optical fiber to support it. The above optical fiber (250) may be supported by the ferrule to maintain irradiation of light to exact position of each component.

All the components of the apparatus for oxygen sensing illustrated in FIG. 2 may not be essential components and an apparatus for oxygen sensing may be materialized by more or less components than those illustrated in FIG. 2.

FIG. 3 is a diagram showing detailed structure of the header part in the apparatus for oxygen sensing according to an example of the present invention.

As shown in FIG. 3, the header part (230) may include an optical fiber (250), a polymer (231) and a sensing material (232).

The above optical fiber (250) may provide a transfer route to the light generated in the above light source (210) using total reflection. In other words, the above optical fiber (250) may provide a path to make the light generated in the light source (210) to the header part (230).

The above header part (230) may provide a path to the light generated in the above light source (210) using a planar optical waveguide instead of the above optical fiber. The above planar optical waveguide is shorter in length and thinner in thickness than the above optical fiber (250), so it may allow intensive constitution of the header part (230) and the above apparatus for oxygen sensing (200) including the same (230), and be useful to change diameter of the light generated in the light source (210).

The above optical fiber (250) may consist of core and cladding inducing total reflection of light to irradiate the light to the sensor (130) without loss of energy.

The above optical fiber (250) may be supported by the ferrule (251). The above optical fiber (250) may be inserted to the above ferrule to compose an assembly. The above optical fiber (250) may be supported by the ferrule (251) to make the light irradiated to the header part (230) vertically.

The above polymer (231) may generate the interference wave to the light irradiated by the light source (210) by the principle of FFPI.

Concretely, the above polymer (231) may function as 2 mirrors of the FFPI. Wherein, front end of the polymer (231) connected to the optical fiber (250) and rear end of the polymer (231) connected to the sensing material (232) may act as 2 mirrors of the FFPI to cause repeated reflection and transmission according to change of the refractive index.

According to another example of the present invention, the above polymer (231) may be coated at the end of optical fiber (250). In addition, the above polymer (231) may be coated in a shape of curved surface such as a hemisphere.

According to another example of the present invention, the above polymer (231) may be a polymer that is in solid state at room temperature or operation temperature of the apparatus for oxygen sensing (200). For example, the above polymer (231) may be poly-dimethylsiloxane (PDMS).

The above PDMS is homogeneous, isotropic, and transparent optically up to 300 nm of thickness, so may be suitable to a material between 2 mirrors making the header part (230) act as the FFPI.

According to another example of the present invention, the above sensing material (232) may change its effective refractive index by combination with oxygen. In other words, the above sensing material (232) may form chemical combination with oxygen and change its effective refractive index according to this. The above interference wave may change its spectrum periodicity according to the refractive index change of the sensing material (232).

Considering thickness of the sensing material (232) in nm unit, the refractive index change of the above sensing material acting as a material of the interferometer may cause a change of effective refractive index to the mirror of interferometer comprising the sensing material (232) and external air, and eventually spectrum change of the interference wave.

The above apparatus for oxygen sensing (100) can decide existence of oxygen based on this change of spectrum periodicity of the interference wave. According to another example of the present invention, the above sensing material (232) may be at least one of globins including hemoglobin, myoglobin, and metal-porphyrin.

Hemoglobin has 2 alpha and 2 beta chains and includes heme, a pigment having Fe-protoporphyrin structure. Fe located in the center of heme combines with nitrogen (N) in 4 pyrrole rings. In addition, Fe combines with oxygen molecule in exterior and rotates angle of the above pyrrole rings. Hemoglobin forms coordination bond, where this structural change increases bonding strength with oxygen.

This combination of hemoglobin makes absorption and desorption with oxygen and becomes a cause to have an optical property to change its refractive index depending on surrounding oxygen concentration. Therefore, the above hemoglobin can sense oxygen more efficiently by being used as the sensing material (232).

According to another example of the present invention, the above sensing material (232) may be coated at the end of polymer (231).

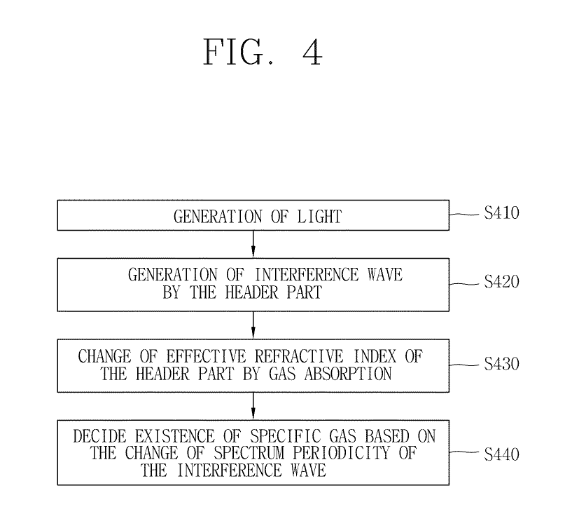

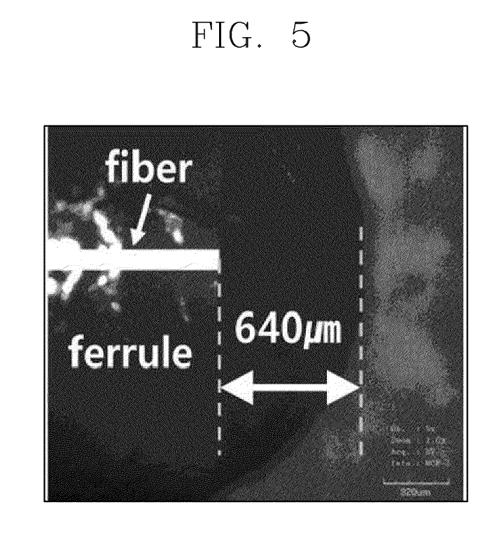

FIG. 4. Is a flowchart illustrating a method for oxygen sensing according to an example of the present invention.

As shown in FIG. 4, the apparatus for oxygen sensing (200) generates light (S410) at first.

The above apparatus for oxygen sensing (200) may generate light using the light source (210).

Next, the above apparatus for oxygen sensing (200) generates interference wave (S420).

The above apparatus for oxygen sensing (200) may generate interference wave to the light generated by the header part (230) by the principle of FFPI.

The above apparatus for oxygen sensing (200) may generate the interference wave through the polymer (231) and the sensing material (232) included in the header part (230).

The above polymer (231) may function as 2 mirrors of the FFPI. Wherein, front end of the polymer (231) connected to the optical fiber (250) and rear end of the polymer (231) connected to the sensing material (232) may act as 2 mirrors of the FFPI to cause repeated reflection and transmission according to change of the refractive index.

According to another example of the present invention, the above polymer (231) may be coated at the end of optical fiber (250). In addition, the above polymer (231) may be coated in shape of a plane or a curved surface such as a hemisphere as shown in FIG. 3.

According to another example of the present invention, the above polymer (231) may be a polymer that is in solid state at room temperature or operation temperature of the apparatus for oxygen sensing (200). For example, the above polymer (231) may be poly-dimethylsiloxane (PDMS).

The above sensing material (232) may generate the interference wave to the light irradiated by the light source (210) by the principle of FFPI. In other words, front end of the sensing material (232) connected with the above polymer (231) may generate interference wave by acting as mirror of the FFPI.

According to another example of the present invention, the above sensing material (232) may be at least one of globins including hemoglobin, myoglobin, and metal-porphyrin.

According to another example of the present invention, the above sensing material (232) may change its effective refractive index by combination with oxygen (S430).

In other words, the above sensing material (232) may form chemical combination with oxygen and change its effective refractive index according to this.

The above interference wave may change its spectrum periodicity according to the effective refractive index change of the sensing material (232).

Finally, the above apparatus for oxygen sensing decides existence of oxygen based on change of spectrum periodicity of the interference wave.

The above apparatus for oxygen sensing can analyze spectrum periodicity of the interference wave and decide existence of oxygen using the above OSA (240).

The above apparatus for oxygen sensing (200) may analyze if the spectrum periodicity of the interference wave is changed by combining with the oxygen and changing its effective refractive index (232). Namely, the above apparatus for oxygen sensing (200) may analyze if the spectrum periodicity of the interference wave is changed by wavelength change from change of the effective refractive index of the sensing material (232).

When the spectrum periodicity of the above interference is changed compared with when no oxygen exists in the air, the above apparatus for gas sensing (200) may decide it as oxygen exists in the air.

Next, results of sensing oxygen by using the above apparatus for oxygen sensing (200) according to another example of the present invention are analyzed and explained.

Below results are obtained by analyzing results sensed by using PDMS as the polymer and hemoglobin as the sensing material.

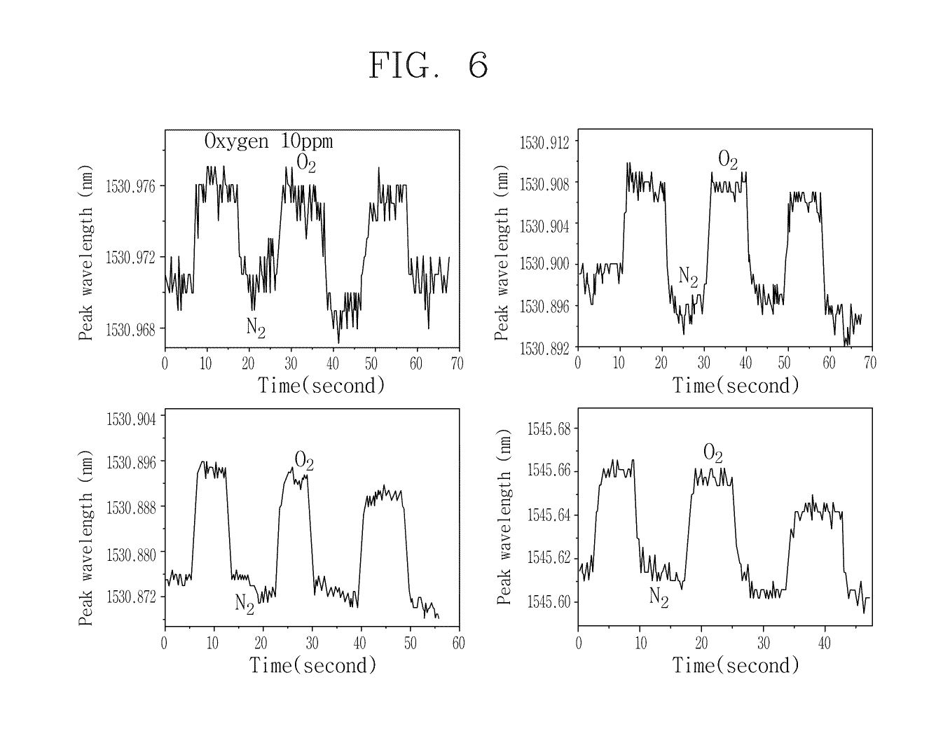

FIG. 5 is a microscopic image of the header part in the apparatus for oxygen sensing according to an example of the present invention.

As shown in FIG. 5, a microscopic image of the hemoglobin coated header part to sense oxygen is illustrated.

As the polymer, PDMS is coated on the section of optical fiber in a shape of hemisphere. In another example of the present invention, the thickness of PDMS with hemispheric shape is 640 μl.

In addition, the above hemoglobin is diluted in distilled water to 0.1 wt %, coated on the surface of PDMS, and dried in nitrogen at room temperature to be used as the sensing material (232).

FIG. 6 is a diagram showing spectrum periodicity change of the reflected interference wave in the apparatus for oxygen sensing according to an example of the present invention.

In another example of the present invention, 100 ppm of standard oxygen concentration diluted with nitrogen and pure nitrogen were used in order to identify reactivity to low concentration oxygen and results of spectrum periodicity change. Wherein, the oxygen and nitrogen gas were put into gas tank having Mass Flow Controller (MFC) on its discharge pipe respectively to mix them and control oxygen concentration under control of the MFC. In order to mix them sufficiently, they were made to pass through a pipe as long as 1 m and reach the header part (230) of the above apparatus for oxygen sensing (200).

The above low concentration oxygen controlled by the MFC includes 50 ppm, 30 ppm, 20 ppm, and 10 ppm and total gas flow was set to 200 sccm,

As shown in FIG. 6, changes of spectrum peak values according to time passage with alternative inflow of oxygen and pure nitrogen were made a graph depending on oxygen concentration.

Referencing the graph, it is identified that the wavelength of interference wave moves to longer wavelength with increase of oxygen concentration. On the contrary, it is identified also that the wavelength of the interference wave moves to shorter wavelength with decrease of oxygen concentration from inflow of nitrogen.

This is because the hemoglobin used as the sensing material combines with the oxygen flown in or is disconnected from discharge of oxygen, so its effective refractive index changes and the wavelength of interference wave changes also by the principle of FFPI.

Therefore, the above apparatus for oxygen sensing can sense existence of oxygen based on spectrum periodicity change of the interference wave.

In addition, it is identified that the apparatus for oxygen sensing according to another example of the present invention has very fast reaction velocity to oxygen through the graph in FIG. 6 that shows dramatic change of wavelength according to inflow/outflow of oxygen.

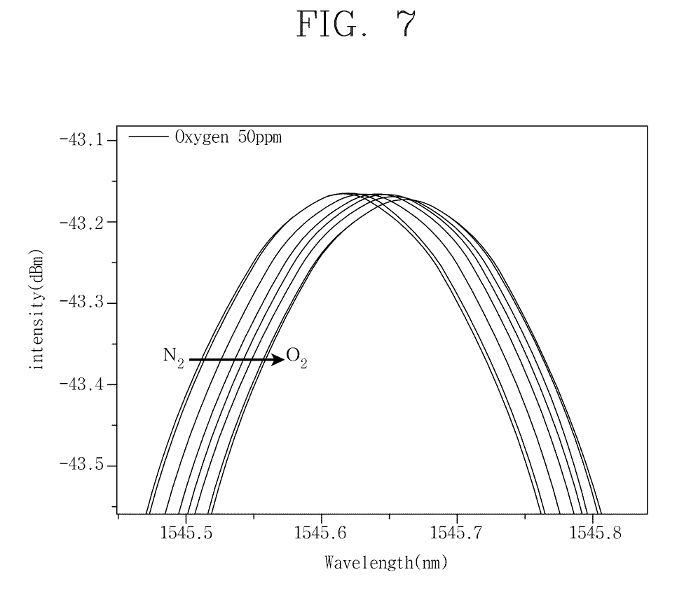

FIG. 7 is a diagram showing results of oxygen concentration change in the apparatus for oxygen sensing according to an example of the present invention.

As shown in FIG. 7, it is possible to see change of intensity curve of the interference wave during the oxygen concentration increases to 50 ppm. According to this, it is found that wavelength of the interference wave moves by 0.7 nm during the oxygen concentration increases from 1545.61 nm to 1545.68 nm.

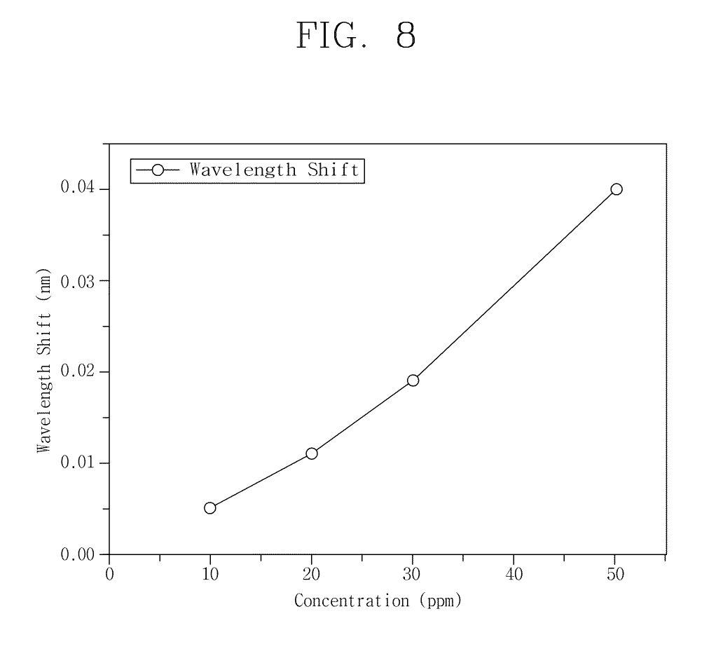

FIG. 8 is a diagram showing results of spectrum periodicity change of the interference wave depending on change of oxygen concentration in the apparatus for oxygen sensing according to an example of the present invention.

As shown in FIG. 8, it was identified that wavelength movement of the interference wave increases with increase of oxygen concentration. It means that when the oxygen concentration is higher, the above sensing material combines with more oxygen and causes larger change of the refractive index, so the wavelength of the interference wave moves more.

When the oxygen concentration was 10 ppm, the wavelength of interference wave moved about 0.005 nm. It is considered that the 10 ppm of oxygen concentration is minimum measurement limit able to distinguish the movement of wavelength via the OSA.

When analyzing function of the apparatus using oxygen below 10 ppm, it may be possible to identify lower minimum measurement limit. This shows that the apparatus for oxygen sensing according to another example of the present invention has much higher sensitivity to oxygen, comparing conventional apparatuses for oxygen sensing.

In addition, the apparatus for oxygen sensing can sense existence of oxygen without consumption of oxygen by using hemoglobin forming a reversible bond with oxygen as a sensing material.

As the present features may be embodied in several forms without departing from the characteristics thereof, it should also be understood that the above-described embodiments are not limited by any of the details of the foregoing description, unless otherwise specified, but rather should be construed broadly within its scope as defined in the appended claims, and therefore all changes and modifications that fall within the metes and bounds of the claims, or equivalents of such metes and bounds are therefore intended to be embraced by the appended claims.

What is claimed is:

1. An apparatus for oxygen sensing, comprising:
a header part to generate interference wave to light generated in a light source by the principle of fiber Fabry-Perot interferometer; and
an optical spectrum analyzer to decide existence of oxygen based on change of spectrum periodicity of the above interference wave,
wherein the header part includes a sensing material of which effective refractive index changes by combination with the oxygen and the above interference wave changes its spectrum periodicity depending on change of effective refractive index of the above sensing material.

2. The apparatus of claim 1, wherein the above sensing material is one of globins including hemoglobin, myoglobin, and metal prophyrin.

3. The apparatus of claim 1, wherein the apparatus includes also a circulator that discharges the light generated in the light source and entering into the first port to the head part linked to the second port, and discharges the interference wave generated in the header part and entering into the second port to the optical spectrum analyzer linked to the third port.

4. The apparatus of claim 1, wherein the header part includes also an optical fiber or an optical waveguide that provides transfer route of the light generated in the light source using total reflection of light; and a polymer that is coated at the end of the optical fiber supported by ferrule and acts as 2 mirrors of the fiber Fabry-Perot interferometer, and the above sensing material is coated on the surface of the above polymer.

5. The apparatus of claim 4, wherein the above polymer is one of polymers including poly-dimethylsiloxane (PDMS) that is in solid state at room temperature or its operation temperature.

6. The apparatus of claim 4, wherein the above polymer is coated in a shape of curved surface including a plane or a hemisphere.

7. A header part of the apparatus for oxygen sensing, comprising:
an optical fiber or an optical waveguide providing a transfer route of the light generated in the light source using total reflection;
a polymer coated at the end of the optical fiber and acting as 2 mirrors of the fiber Fabry-Perot interferometer; and
a sensing material coated at the end of the above polymer and generating an interference wave by the principle of fiber Fabry-Perot interferometer to the light generated in the light source and entering through the optical fiber or the optical waveguide,
wherein the above sensing material changes its effective refractive index and the above interference wave changes its wave length depending on the effective refractive index change of the above sensing material.

8. The header part of claim 7, wherein the above sensing material is one of globins including hemoglobin, myoglobin, and metal prophyrin.

9. The header part of claim 7, wherein the above polymer is one of polymers including poly-dimethylsiloxane (PDMS) that is in solid state at room temperature or its operation temperature.

10. The header part of claim 7, wherein the above polymer is coated in a shape of curved surface including a plane or a hemisphere.
